(19) United States
(12) Patent Application Publication
(10) Pub. No.: US 2009/0108073 A1
(43) Pub. Date: Apr. 30, 2009

(54) METHOD AND APPARATUS FOR ALIGNING A CODE AND A READER WITHOUT DISPLAYING A BACKGROUND IMAGE

(76) Inventor: Carl W. Gerst, Clifton Park, NY (US)

Correspondence Address: COGNEX CORPORATION;INTELLECTUAL PROPERTY DEPARTMENT, 1 VISION DRIVE, NATICK, MA, 01760-2077, US

(21) Appl. No.: 11/932,317

(22) Filed: Oct. 31, 2007

(51) Int. Cl. G06K 7/10

(52) U.S. Cl. 235/462.41

(57) ABSTRACT

A method and system for verifying a two dimensional mark without the need to transfer an image between a verification system having a data collector and host software connected to a display, the method comprising the steps of displaying a blank background image corresponding to the data collector field of view on the display, using the data collector to scan for a code at least in part within the field of view, identifying an item that may correspond to a code, graphically representing the identified item on the display in a location corresponding to the actual location within the field of view, monitoring the position of the identified item, attempting to verify the code when the identified item is at an aligned position, and indicating that the code has been verified. In one embodiment, an image of the code only may be displayed and/or transferred to the host software.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

The present invention relates to mark verification systems in secure environments and more specifically to a method of correctly positioning an item marked with a two dimensional code, e.g., a Data Matrix code, or arranging a code reader associated with the verification system without showing or acquiring an image from the field of view of the code reader.

Many different industries require that some form of identification mark be applied to manufactured components so that the components may be tracked during distribution, when installed or assembled, during maintenance processes, during use, and after use. For instance, in the jet engine industry, jet engines include, among other components, turbines that include turbine blades that are manufactured in various size lots. Each turbine blade is marked when manufactured so that the blade may be tracked. If a defect is ever detected in the blade, the defect can be traced back to a specific lot and manufacturing process associated therewith so that possible defects in other blades from the same lot can be identified. Furthermore, the maintenance history of specific components can be tracked to identify positive or negative characteristics of specific materials and/or processes used to produce the components. Marks that are applied directly to components or parts are generally referred to as direct part marks (DPMs).

To directly mark components, known marking systems have been developed that include a marking station to apply a mark to each component. For instance, in at least some known cases, a marking station will apply a Data Matrix barcode symbol, i.e., a two-dimensional barcode that stores from 1 to 2,335 alphanumeric characters, to each manufactured component. An exemplary Data Matrix symbol is typically square and can range from 0.001 inch per side up to 14 inches per side.

Despite attempts to apply marks that can be read consistently thereafter, mark application errors occur such that the mark cannot be subsequently consistently read and decoded properly. To verify that applied marks are of sufficient quality to be read by code readers, marking systems often include, in addition to the aforementioned marking station, a verification station and at least a portion of a transfer line to transfer components from the marking station to the verification station. After a mark is applied to a component, the component is transferred to the verification station where the mark must be precisely aligned with a light source and a camera/mark reader. The verification station may be stationary, wherein the station is juxtaposed such that the camera, or reader, field of view is aligned with a location through which the component will pass.

The verification station may include stationary mechanisms (e.g., mechanical locking devices, sensors, etc.) for aligning the component with the light source and camera such that the mark is optimally presented. Upon proper positioning, the camera or reader can capture an image of the mark and a host system processor can analyze mark verifying information from the mark. Alternatively, the verification station may include a handheld code reader or other portable camera device for obtaining the mark images to be analyzed.

While marking and verification systems of the above kind work well to verify component mark quality, such systems have a number of shortcomings. A number of these shortcomings result from the potentially unregulated use of cameras and image capture devices in secure facilities. Standard verification systems contain a camera that takes and stores pictures of an entire camera or verifier field of view. The field of view is not limited to just a code but typically includes a signification portion of a marked component. Even worse, in the case of verification station with a handheld reader or a handheld reader generally, the reader can be moved such that the available field of view includes anything within a secure facility. Furthermore, due to its portable nature, a handheld reader can be moved to other remote areas away from intended usage areas.

This creates the potential for unauthorized data acquisition, i.e., industrial espionage, by permitting the taking and storing of pictures for later retrieval. This in turn has kept standard verification systems and handheld code readers with image acquisition capabilities from being used in certain applications. Unauthorized images could be strategically used by competitors to anticipate future developments, acquire trade secrets including specific equipment used, manufacturing specifics, or even record the identities of specific personnel.

This potential is even more of an issue in secure and/or classified production environments such as are found in government research and testing facilities, military bases, military contractor production facilities, and the like. Many of these facilities could benefit by using DPMs, but due to the restrictions on cameras, cannot use standard verification systems.

One known solution to this problem is to never shown an image of the field of view, and thus the code, nor let any images be recorded in the memory of the verification system. This solution is less than ideal because users generally prefer to be able to see an image of a code immediately after a successful verification or read attempt. Furthermore, the ability to see the reader field of view facilitates setting up a verification or reader station and improves the scan speed when using a handheld reader. The lack of real-time images results in a lack of information presented to the user and may cause unneeded re-work or waste due to the inability to read an otherwise acceptable mark.

These and other objects and advantages of the invention will be apparent from the description that follows and from the drawings which illustrate embodiments of the invention, and which are incorporated herein by reference.

### BRIEF SUMMARY OF THE INVENTION

An illustrative embodiment of the present invention provides a method for aligning a code reader with a code to be read or imaged, without displaying an image of items within the field of view of the reader. The method includes the steps of providing a blank background image on a display corresponding to a data collector field of view, scanning for a code at least partially contained within the field of view, identifying an item that may correspond to a code, and graphically representing the identified item in the blank background image in a location corresponding to the actual location of the identified item within the field of view. Further steps of this method may include defining at least one desired code position, graphically presenting the desired position on the blank background corresponding to the actual location of the desired position, monitoring the position of the identified item to ascertain when the identified item is in the desired position, providing an indication when the item is at the desired position and/or has been verified.

In some cases the step of graphically representing the identified item on the blank background includes presenting a colored rectilinear boundary line, i.e., box, that circumscribes the outline of the identified item without showing an image of the identified item. Also, the step of graphically presenting the desired position on the blank background may include presenting a rectilinear shape in a second color corresponding to the desired code location.

In a further embodiment, the box representing the code changes position and/or size in response to either movement of the reader or movement of the code. The box representing the code may also change color in response to the code: being properly aligned within the field of view, being at an acceptable angle in relation to the reader, and having acceptable perspective distortion.

In a further embodiment, when the field of view of the data collector is aligned along a central axis and the code to be scanned is formed on a substrate surface, the method further includes the steps of identifying the angle of the central axis to the substrate surface and providing an indication of the angle between the central axis and the substrate surface. The method may further include providing an indication when the angle is within an acceptable range.

In a further embodiment, further steps include obtaining data corresponding to the identified item and attempting to decode the identified item. If the identified item is successfully decoded and verified, the box representing the identified item is replaced with an image of the code. The code image may be a generated image corresponding to the code wherein the presented code image includes substantially no data from other portions of the field of view. The code image may include cropping the image corresponding to the field of view down to a size substantially corresponding to the code.

In a further embodiment, the reader is a hand held reader and the display is on the hand held reader wherein the blank background and generated code image is presented via the hand held reader display.

In a still further embodiment, an apparatus for obtaining an image limited to a code within an environment comprises: a code reader having a display and a data collector that obtains an image of a field of view, a processor that receives and examines the image of the field of view to identify an item that may correspond to a code; and a display driver that controls information presented via the display. A blank background image is initially shown on the display corresponding to the data collector field of view. A graphical representation of the identified item is also displayed on the blank background corresponding to the actual location of the identified item. At least one desired, or aligned, position for a code within the data collector field of view is defined. The processor monitors the position of the identified item within the field of view to ascertain when the identified item is in the aligned position and indicates via the display when the identified item is in the aligned position.

In an alternative embodiment, an apparatus for generating an image of a code without generating images of other objects within an environment comprises: a code reader having a display and a data collector that obtains an image of a field of view, and a processor that receives and examines the image to identify an item that is at least in part within the field of view and may correspond to a code. The portion of the field of view corresponding to the identified item is a considered a possible code portion of the field of view while the other portions of the field of view are considered background portions of the field of view. After the processor verifies that the identified item is a code, a code image corresponding to the verified code is generated wherein the code image includes substantially no data from the background portions of the field of view. The apparatus further includes a display driver presenting the code image via the display.

In some cases, the processor may verify that the identified item is a code by successfully decoding the identified item. Thereafter, the processor generates a code image corresponding to the verified code by cropping the image corresponding to the field of view down to a size substantially corresponding to the verified code.

To the accomplishment of the foregoing and related ends, the invention, then, comprises the features hereinafter fully described. The following description and the annexed drawings set forth in detail certain illustrative aspects of the invention. However, these aspects are indicative of but a few of the various ways in which the principles of the invention can be employed. Other aspects, advantages and novel features of the invention will become apparent from the following detailed description of the invention when considered in conjunction with the drawings.

### BRIEF DESCRIPTION OF THE SEVERAL VIEWS OF THE DRAWINGS

FIG. 1 is a schematic view illustrating exemplary hand held reader including a display that is consistent with at least some aspects of the invention;

FIG. 2 is a schematic illustrating components of the reader of FIG. 1;

FIG. 3 is a flowchart illustrating at least one method that may be performed by the processor of FIG. 1 to identify and locate a mark;

FIGS. 4A-E are illustrations simulating a potential sequence of displays generated by the reader of FIG. 1;

FIG. 5 is a subprocess that may be added to the process of FIG. 3; and

FIG. 6 is a schematic similar to FIG. 1, albeit illustrating a second system configuration.

### DETAILED DESCRIPTION OF THE INVENTION

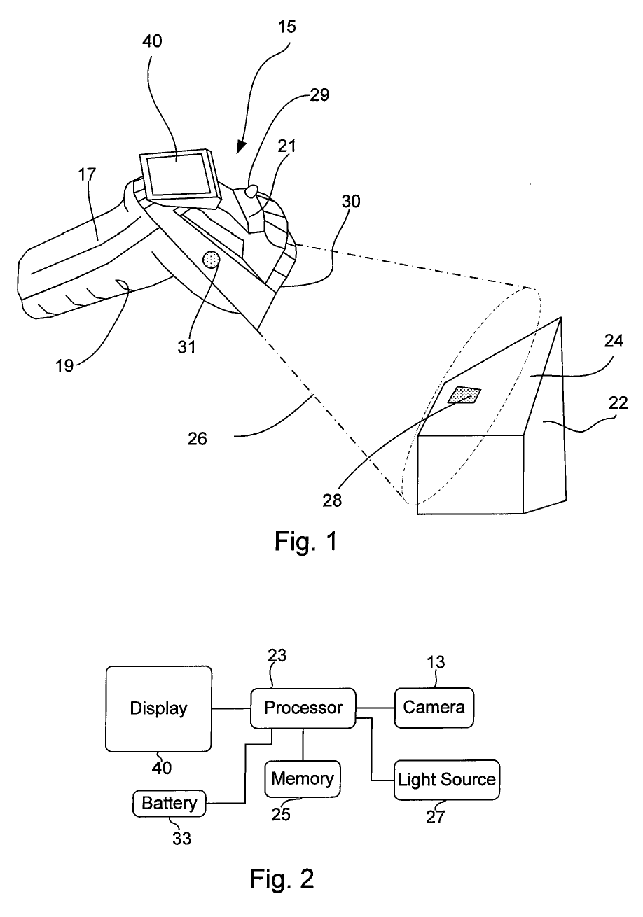

Referring now to the drawings wherein like reference numerals correspond to similar elements throughout the several views and, more specifically, referring to FIG. 1, one inventive embodiment will be described in a context of an exemplary handheld code reader 15 that can be used to obtain images of a mark/code 28 that appears on a surface 24 of a marked item 22. In FIG. 1, reader 15 includes a camera 13 (see also FIG. 2) (e.g., a CCD area or other type) mounted within a generally pistol shaped device housing 17 that includes a handle portion 19 and a barrel portion 21. The camera 13 is arranged in barrel portion 21 so that a field of view (FOV) 30 fans out over an area adjacent a distal edge of the barrel portion 21. A display 40 is mounted at the top end of handle position 19.

Referring also to FIG. 2, reader components inside housing 17 include a processor 23, a memory 25, and a light source 27, where processor 23 is linked to camera 13, light source 27, memory 25 and display 40. Processor 23 runs software programs stored in memory 25 to perform various inventive functions. In addition, processor 23 controls light source 27 to illuminate surfaces on which marks 28 are applied as well as camera 13.

In one embodiment, the image of the mark 28 is processed to verify that the mark 28 is of sufficient quality to be used by subsequent mark readers, e.g., at a customer's facility. To perform the verification process, reader 15 is linked to a host system (not shown) running a verification application. The verification application may be a commercially available software-based direct part mark verification program. Preferred features of such an application include the ability to log, report and communicate verification results, images and information about system set-up, record the overall score and quality metrics for each mark that is verified, time and date-stamp each verification, and store bitmaps of each mark image. A preferred verification application further provides a simple and intuitive graphical user interface (GUI) via a display, or monitor, 106 (see FIG. 6) enabling a user to enter set-up information and see the verification results (e.g., whether or not the quality of the imaged mark meets or exceeds a baseline quality assessment value).

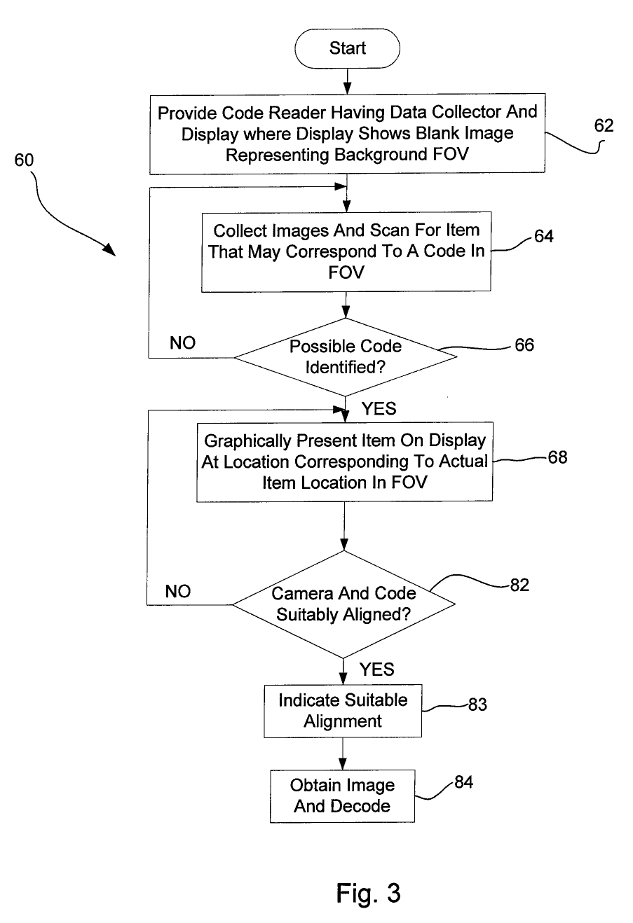

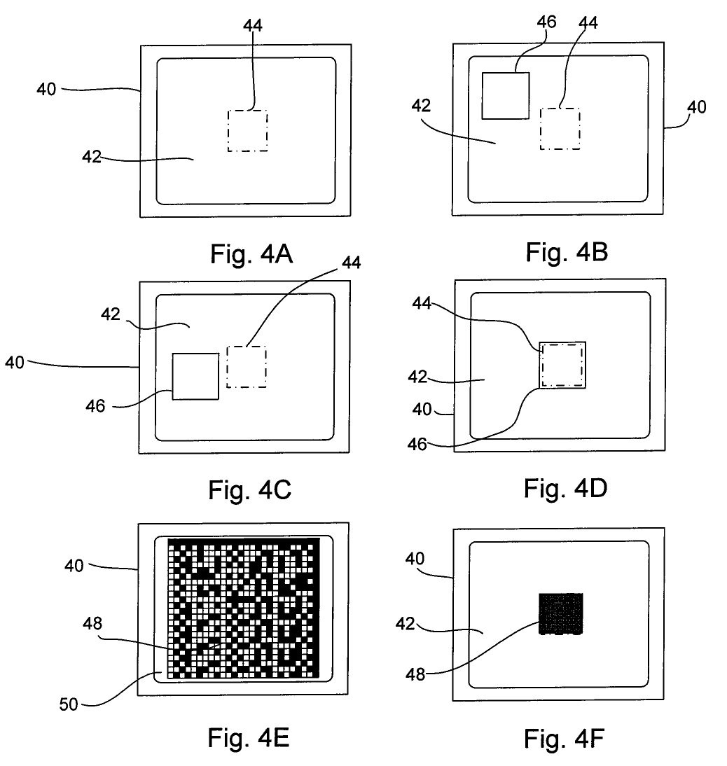

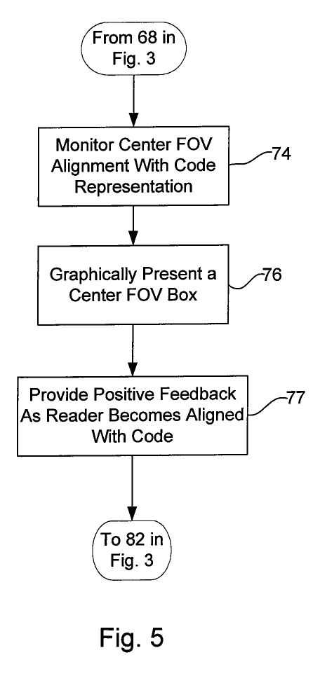

Referring now to FIG. 3, an exemplary method 60 that is consistent with at least some inventive embodiments is illustrated. Referring also to FIGS. 1 and 4, at process block 62 after reader 15 has been enabled by a user, a blank background image or screen 42 is presented on the display 40. The blank screen 42 represents and corresponds to the field of view 26 of camera 13.

To prevent unauthorized image acquisition, screen 42 does not, at least initially, display any actual images from the field of view 26 acquired by camera 13. Instead, display 40 presents blank screen 42 wherein any identified items of interest (e.g., unverified codes 28), are presented as graphical illustrations on the blank background.

At step 64, reader 15 continuously scans for codes or marks 28 at least in part within the field of view 26. As shown in step 66, when reader 15 identifies an item that may correspond with a code 28 at least partially within the field of view 26, the size and location (i.e., the boundary coordinates of the item) relative to the field of view 26 are determined. At block 68, processor 23 graphically presents the identified item at a location within the screen 42 that corresponds to the physical location of the identified item within the field of view 26. To this end, see exemplary box 46 (hereafter “the code representation”) in FIG. 4B that is a graphical representation of an item in the field of view that has characteristics indicative of a code of mark to be read.

In addition to arranging the camera 13 and/or mark 28 such that the mark 28 is at least in part in the aligned position of the field of view 26, a user may also need to satisfy other pre-determined parameters, such as suitably arranging the mark 28 in order to enable the reader 15 to obtain an image of sufficient quality to perform a decoding process. Other than code position, parameters required for obtaining a suitable image may include an angle of the reader 15 relative to the code 28, the amount of perspective distortion of the mark 28, reader focus, etc. In an embodiment not shown, when the field of view 26 of the camera 15 is aligned along a central axis and the mark 28 to be scanned is formed on a substrate surface, the angle between the central axis and the surface is identified and indicated to a user, including when the angle is within an acceptable range.

Referring still to FIG. 3, code-field of view alignment is monitored by processor 23 at decision block 82. Here, alignment is determined by obtaining images of the code, identifying code characteristics and comparing those characteristics to known suitable code characteristics at block 83, when a code is suitably aligned within the reader field of view, suitable alignment is indicated. In at least some embodiments suitable alignment may be indicated by changing the color of the code representation 46 (see again FIG. 4B) from, for instance, red (indicating misalignment) to green (indicating alignment). In other cases, alignment may be indicated by flashing the representation 46 on and off or by illuminating an LED (see 29 in FIG. 1) or the like as activating an audible speaker (see 31 in FIG. 1) mounted to the reader housing 17.

In step 84, after the code 28 and reader 15 are correctly positioned, data or an image corresponding to the identified item is obtained. Reader 15 attempts to de-code the identified item using known decoding software. Where decoding is successful, processor 23 may indicate a successful image capture and decoding process via display 40 or in any other suitable manner (e.g., an LED 29, an audible indication via speaker 31, etc.). In other cases, processor 23 may be programmed to crop the image of the code and present only the image of the code via display 40 in a large format 48 as shown in FIG. 4E. In some embodiments the cropped image may include a small quiet zone around the code/mark. In other embodiments processor 23 may be programmed to present just the image of the code 48 on the blank background 42 instead of the box type and code representation 46 as in FIG. 4F. In still other embodiments, instead of presenting an actual image of the de-coded code, processor 23 may be programmed to synthesize a rendition of the decoded code using the decoded information and the synthesized rendition may be presented via display 40 to indicate successful decoding.

Reader 15 may send the de-coded results and metrics to the host system. The reader 15 may also send an image 48 of the verified code 28, as shown in FIG. 4E. However, the image 48 is limited to the code 28 and a narrow quiet zone 50 therearound only. Additional data captured in the initial image is cropped out by the processor 23 before sending the image 48 to the host system 38. The image 48 of the code 28 may momentarily be shown on the display 40, replacing either the background screen 42 or just the graphical representation 46 of the code 28.

Upon completion of the decoding process, processor 23 may again present a blank background screen 42 on the display 40 until another item that may correspond to a code 28 is identified.

In some embodiments, in addition to providing a code representation box or icon 46 on a blank background as in FIG. 4B, a center of field of view box or icon may also be presented to indicate an ideal or at least suitable location for the code representation 46 that can be used by a reader user to facilitate alignment. To this end see FIG. 4A that shows an exemplary center FOV box/shape 44 on otherwise blank screen 42. Referring also to FIG. 4B, when an item that may correspond to a code is identified in the camera's FOV, box 46 is provided at a location corresponding to the location of the item in the field of view. In FIG. 4B, it should be appreciated that box 46 is misaligned with the center FOV box 44 and therefore the reader 15 or item 22 must be reoriented. Referring to FIG. 4C, as the reader is reoriented, box 46 moves about on display 40 accordingly until, as in FIG. 4D, box 46 is aligned with center FOV box 44 and the reader obtains an image and attempts to decode.

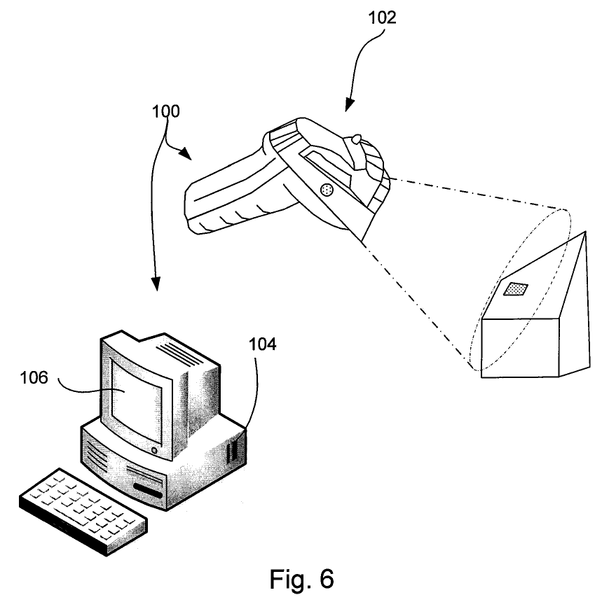

Referring now to FIG. 5, a subprocess that may be included in the process of FIG. 2 for presenting and using a center FOV box 44 is illustrated. Referring also to FIGS. 1 and 2, after block 68, control passes to block 74 where the center FOV box 44 is presented via display 40. At block 76, processor 23 monitors to identify when the code representation box 46 is becoming relatively more aligned with box 44. At block 77 processor 23 provides positive visual or audio feedback as the reader 15 becomes relatively more aligned with the code. Positive visual feedback may include changing the color or box 46 from red to yellow with suitable final alignment being indicated via a green box 46.

Referring to FIG. 6, a second hand held system 100 that is consistent with at least some inventive embodiments is illustrated. The primary difference between system 100 and reader 15 described above is that the reader 102 in system 100 does not include a display and instead information from reader 102 is transmitted e.g., wirelessly or through a cable (not illustrated) to a computer 104 including a display 106. Images generated on the hand held display 40 above are generated via display 106 in system 100. Although the embodiments described above are in the context of a hand held reader, other embodiments are contemplated where a reader is mounted to a stationery structure and items are moved along a transfer line or the line adjacent thereto. In this case the inventive system may be useable during a commissioning process to align a camera FOV with a repeatable location and orientation of codes/marks to be read. Here again, no images other than sub-images of codes would be stored or presented via a display. Moreover, although not illustrated, the inventive code representation system could be used in a mark verification application.

One or more specific embodiments of the present invention have been described above. It should be appreciated that in the development of any such actual implementation, as in any engineering or design project, numerous implementation-specific decisions must be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure. For example, in some cases where a reader is to be used with a specific code type, processor 23 may be programmed with a synthetic rendition of a generic instance of the specific code type and that image or a permutation thereof (e.g., squished or skewed depending upon reader orientation with respect to the mark being imaged) may be presented instead of the representation box 46. Here, the generic instance would, for practical purposes, have the appearance of the mark actually being imaged and decoded.

Thus, the invention is to cover all modifications, equivalents, and alternatives falling within the spirit and scope of the invention as defined by the following appended claims. For example:

What is claimed is:

1. A method for use with a code reader that includes a display and a data collector, the data collector including a field of view, the method for aligning the data collector with a code to be scanned without displaying a live image of the field of view, the method comprising the steps of:
providing a blank background image on the display wherein the blank background image corresponds to the data collector field of view;
using the data collector to scan for a code that is at least in part within the data collector field of view;
identifying an item that is at least in part within the field of view that may correspond to a code; and
graphically representing the identified item at a location on the blank background corresponding to the location of the identified item within the data collector field of view.

2. The method of claim 1 further including the steps of defining at least one aligned position for a code within the data collector field of view and monitoring the position of the identified item within the field of view to ascertain when the identified item is in the at least one aligned position.

3. The method of claim 2 further including the step of, when the identified item is in the at least one aligned position, indicating that the item is at the aligned position.

4. The method of claim 1 further including the steps of defining at least one aligned position for a code within the data collector field of view and graphically presenting the at least one aligned position on the blank background corresponding to the location of the at least one aligned position within the data collector field of view.

5. The method of claim 1 wherein the step of graphically representing the identified item at a location on the blank background corresponding to the location of the identified item within the data collector field of view includes presenting a boundary line that circumscribes the identified item within the field of view without showing the identified item.

6. The method of claim 5 wherein the boundary line has a rectilinear shape and is presented in a first color.

7. The method of claim 6 further including the steps of defining at least one aligned position for a code within the data collector field of view and graphically presenting the at least one aligned position as a rectilinear shape in a second color on the blank background corresponding to the location of the at least one aligned position within the data collector field of view.

8. The method of claim 5 wherein the boundary line changes at least one of position and size in response to at least one of movement of the reader and movement of the code.

9. The method of claim 5 wherein the boundary line changes color in response to at least one of the boundary line being aligned with the data collector field of view, an angle of the code in relation to the reader being within an acceptable range and the perspective distortion of the code being within an acceptable range.

10. The method of claim 1 wherein the field of view of the data collector is aligned along a central axis and the code to be scanned is formed on a substrate surface, the method further including the steps of identifying the angle of the central axis to the substrate surface and providing an indication of the angle between the central axis and the substrate surface.

11. The method of claim 10 wherein the step of providing an indication of the angle includes providing an indication when the angle is within an acceptable range.

12. The method of claim 13 further including the step of obtaining data corresponding to the identified item and attempting to decode the identified item.

13. The method of claim 12 wherein, when the identified item is successfully decoded, the method further includes the step of replacing the graphically represented identified item with an image of the decoded code.

14. A method for use with a display and a code reader, the code reader including a data collector to obtain an image of a code, the data collector including a field of view, the method comprising the steps of:
using the data collector to obtain an image of the field of view;
identifying an item in the obtained image that may correspond to a code wherein the portion of the field of view corresponding to the identified item is a possible code portion of the field of view and the other portions of the field of view are background portions of the field of view;
verifying that the identified item is a code, a code that has been verified being a verified code;
generating a code image corresponding to the verified code wherein the code image includes substantially no data from the background portions of the field of view; and
presenting the code image via the display.

15. The method of claim 14 wherein the step of verifying that the identified item is a code includes successfully decoding the identified item.

16. The method of claim 14 wherein the step of generating a code image corresponding to the verified code includes cropping the image corresponding to the field of view down to a size substantially corresponding to the verified code.

17. The method of claim 14 wherein the reader is a hand held reader and the display is on the hand held reader, the step of presenting including presenting the code image via the hand held reader display.

18. The method of claim 15 wherein the step of obtaining the image further includes the steps of:
determining the location of the code within the field of view;
providing a blank background image on the display wherein the blank background image corresponds to the data collector field of view
graphically representing at least the boundary of the code on the display in relation to the field of view; and
acquiring the image when the code is optimally positioned within the field of view.

19. The method of claim 15 wherein the center of the field of view is identified on the display by a first graphical object and the location of the mark within the field of view is graphically represented as a second object.

20. The method of claim 19 wherein the first and second objects are substantially rectilinear shapes and are first and second different colors, respectively.

21. An apparatus for obtaining an image of a code without generating an image of other objects within an environment, the apparatus comprising:
a code reader that includes a display and a data collector, the data collector including a field of view and obtaining an image of the field of view;
a processor receiving the image of the field of view and examining the image of the field of view to identify an item that is at least in part within the field of view that may correspond to a code; and
a display driver for controlling information presented via the display, the driver providing a blank background image on the display wherein the blank background image corresponds to the data collector field of view, the driver further presenting a graphical representation of the identified item at a location on the blank background corresponding to the location of the identified item within the data collector field of view.

22. The apparatus of claim 21 wherein at least one aligned position for a code within the data collector field of view is defined and the processor monitors the position of the identified item within the field of view to ascertain when the identified item is in the at least one aligned position and, when the identified item is in the at least one aligned position, indicating that the item is at the aligned position via the display.

23. An apparatus for generating an image of a code without generating images of other objects within an environment, the apparatus comprising:
a code reader that includes a display and a data collector, the data collector including a field of view and obtaining an image of the field of view;
a processor receiving the image of the field of view and examining the image of the field of view to identify an item that is at least in part within the field of view that may correspond to a code, the portion of the field of view corresponding to the identified item being a possible code portion of the field of view and the other portions of the field of view being background portions of the field of view, the processor further verifying that the identified item is a code, a code that has been verified being a verified code and generating a code image corresponding to the verified code wherein the code image includes substantially no data from the background portions of the field of view; and
a display driver presenting the code image via the display.

24. The apparatus of claim 23 wherein the processor verifies that the identified item is a code by successfully decoding the identified item.

25. The apparatus of claim 23 wherein the processor generates a code image corresponding to the verified code by cropping the image corresponding to the field of view down to a size substantially corresponding to the verified code.
